(19) United States
(12) Patent Application Publication
(10) Pub. No.: US 2025/0357575 A1
(43) Pub. Date: Nov. 20, 2025

(54) POWER RECEIVING MODULE FOR ELECTRIC MACHINE

(71) Applicant: Caterpillar Inc., Peoria, IL (US)

(72) Inventors: Prashanth PADMANABHAN, Karnataka (IN); Tushar D. ATHALE, Bangalore-Kainataka (IN); Adam BENEDICT, Cardington, OH (US); Sooraj KANNADIPARAMBIL, Karnataka (IN); Basheer QATTUM, Peoria, IL (US); Dustin C. SELVEY, Eureka, IL (US); Nitin PANDEY, Chhattisgarh (IN); Joshua WETTERICH, Dunlap, IL (US); Dachuan YU, Dunlap, IL (US)

(73) Assignee: Caterpillar Inc., Peoria, IL (US)

(21) Appl. No.: 18/667,360

(22) Filed: May 17, 2024

(51) Int. Cl. H01M 10/6563; H01M 10/44; H01M 10/48; H01M 10/613; H01M 10/625; H01M 10/6566; H02J 7/00

(52) U.S. Cl. CPC H01M 10/6563; H01M 10/441; H01M 10/486; H01M 10/613; H01M 10/625; H01M 10/6566; H02J 7/0042; H01M 2220/20

(57) ABSTRACT

A power receiving module may include a front portion, a back portion, a charging input disposed on the front portion, an air intake including a blower disposed on the front portion, the blower configured to direct air through the power receiving module along an air flow path. The power receiving module may be configured to supply power to a battery pack installed in a machine outside of the power receiving module. The power receiving module may further include a first electrical circuit including the charging input, the charging input configured to accept power at a first voltage via a charging connector, and an electrical contactor.

### TECHNICAL FIELD

The present disclosure relates generally to methods and systems for electric machine components and, more particularly, to systems and methods for an air-cooled power receiving module for a battery-powered electric machine.

### BACKGROUND

The electrification of electric mobile industrial machines, while beneficial, presents several technical challenges. Mobile industrial machines require large numbers of battery packs and corresponding high voltage power inputs to receive power to charge the battery packs. High speed charging typically requires a cooling system working in tandem with the charging system to prevent various components from overheating. Cooling implementations for mobile industrial machines are typically bulky, non-modular, liquid-cooled, and difficult to service in the field.

An exemplary battery module is described in EP 2,210,764 A2 (“the '764 publication”) to Taghikhani et. al. The battery module described in the '764 publication is used in an electric vehicle and includes a housing and a member provided within the housing that contains a plurality of electrochemical cells. The member includes apertures in an outer surface of the member that allow a thermal management fluid (e.g., a liquid or a gas such as air) to exit the member after passing adjacent outer surfaces of the plurality of the electrochemical cells within the member. The '764 publication also describes a plug-in module that is configured to couple to a source of power for charging the battery and to provide a visual or other indication of a battery system condition (e.g., full charge, low charge, etc.). However, the '764 publication does not describe a housing designed with high power transfer and that may provide cooling to charging receptacles.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a power receiving module, may include a front portion, a back portion, a charging input disposed on the front portion, an air intake including a blower disposed on the front portion, the blower configured to direct air through the power receiving module along an air flow path. The power receiving module may be configured to supply power to a battery pack installed in a machine outside of the power receiving module. The power receiving module may further include a first electrical circuit including the charging input, the charging input configured to accept power at a first voltage via a charging connector, and an electrical contactor.

In another aspect, a power receiving module may include, a front portion, an intake fan disposed on the front portion, a charging input disposed on the front portion, the charging input configured to accept power at a first voltage via a charging connector, a voltage transducer configured to convert the first voltage to a second voltage, a grounding busbar electrically coupled to both a first electrical circuit and a second electrical circuit, a controller configured to transmit signals for controlling the intake fan and the electrical contactor, an air flow path in thermal communication with at least the intake fan, the charging input, the voltage transducer and the grounding busbar, and one or more service panels. At least one of (i) the electrical contactor, (ii) the voltage transducer, the grounding busbar, or (iv) the controller may be accessible from the power receiving module via at least one of the one or more service panels.

In still another aspect, a method performed by a power receiving module, may include receiving power at a first voltage via a charging input, transmitting an indication from a controller to an electrical contactor, based on the indication, transitioning the electrical contactor between a first configuration and a second configuration. The second configuration may electrically couple a first circuit and a second circuit. The method may further include converting power from the first voltage to a second voltage via a voltage transducer electrically coupled to the second electrical circuit and supplying power to a battery pack. The battery pack may be electrically coupled to the second electrical circuit and configured to accept power at the second voltage. The method may further include directing air through an air filter disposed on a front portion of the power receiving module via a fan. Once inside the power receiving module, the air may pass over the charging input before passing over at least one of the voltage transducer or the electrical contactor, the air being discharged from the power receiving module via an air outlet disposed on a rear portion of the power receiving module.

### BRIEF DESCRIPTION OF THE DRAWINGS

FIG. 1 is a diagram of a machine, according to aspects of the disclosure.

FIG. 2 is a schematic perspective view of a front portion of a power receiving module system, according to aspects of the disclosure.

FIG. 3 is a schematic perspective view of a back portion of the power receiving module system of FIG. 2, according to aspects of the disclosure.

FIG. 4 is a schematic perspective view of a low voltage harness path useful in the power receiving module system of FIG. 2, according to aspects of the disclosure.

FIG. 5 is a schematic perspective view of an air intake useful in the power receiving module system of FIGS. 2 and 3, according to aspects of the disclosure.

FIG. 6 is a schematic perspective view of an air flow path useful in the power receiving module system of FIGS. 2 and 3, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

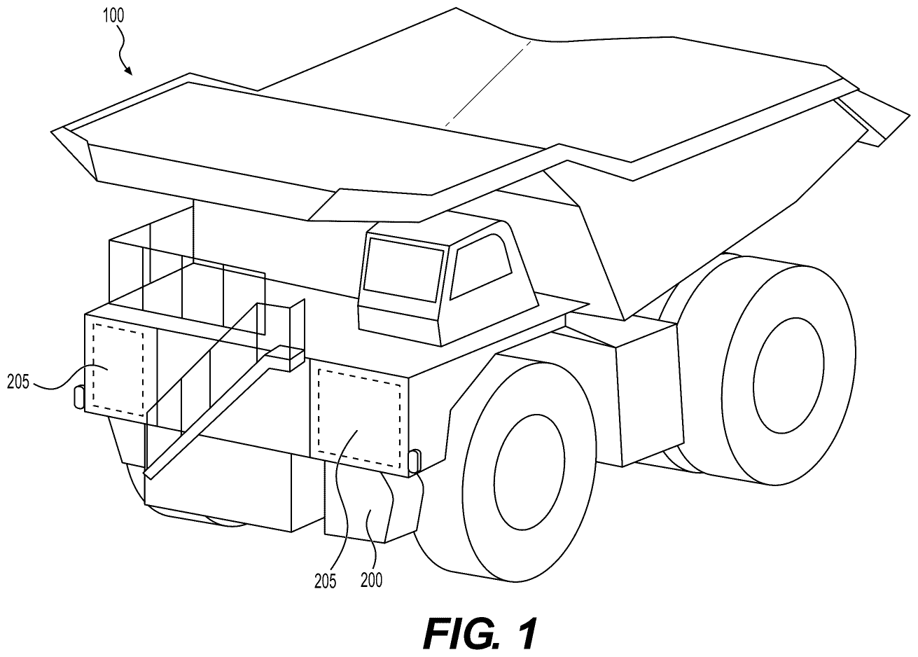

FIG. 1 illustrates an exemplary mobile industrial machine 100 (“machine 100”), according to aspects of the disclosure. Machine 100 is depicted as a battery-powered haul truck for surface mining in FIG. 1, but one of ordinary skill in the art will appreciate that the systems, devices, and methods of the disclosure are applicable to a wide variety of battery-powered electric machines such as underground haulers, loaders, excavators, dozers, pavers, compactors, etc. The disclosure is also be applicable to other applications, such as large-scale battery energy storage systems and electrically-powered vehicles such as semi-trailer trucks. The disclosure may also be applicable to autonomous machines, for example, an autonomous mobile industrial machine capable of positioning itself to receive a charging connection. The disclosure may be further applicable to manual charging connections as well.

Machine 100 accepts charging voltages on the order of 1500 V, though this is only exemplary. Due to the large input voltage, a power receiving module (PRM) 200 of machine 100 is configured to be safe for operators to interact with (e.g., service) and be adequately cooled due to heat generation during charging operations. The depicted location of PRM 200, at a lower-front corner of machine 100, is only exemplary, one of ordinary skill in the art will appreciate that PRM 200 may be located elsewhere on machine 100.

PRM 200 supplies power to a battery pack 205. Battery pack 205 may feature a plurality of modules (not shown) and the plurality of modules may feature a plurality of cells (not shown). The depicted locations of battery pack 205 are only exemplary and other locations of battery pack 205 are possible.

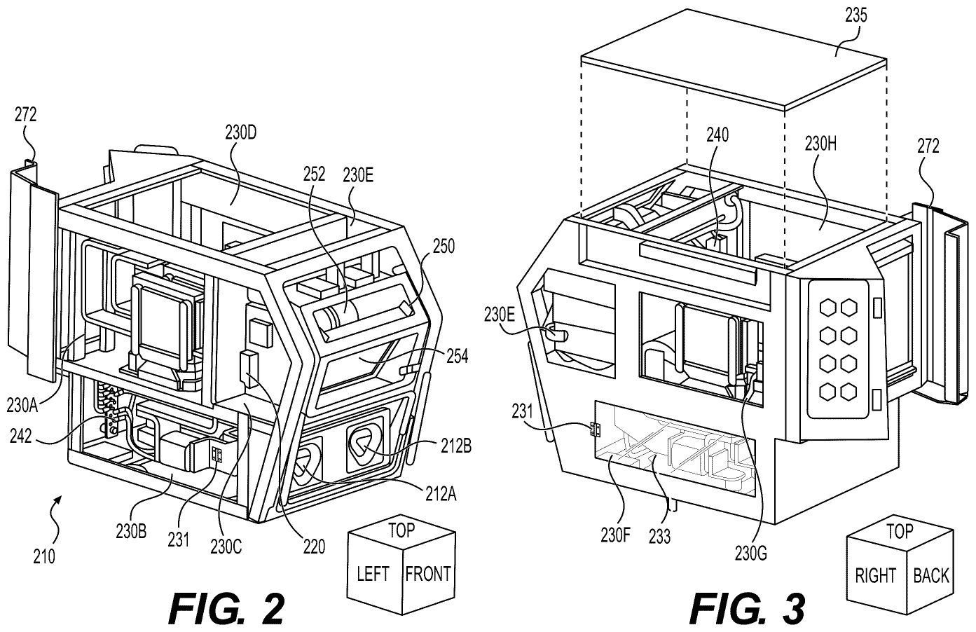

FIG. 2 is a perspective view of the front of power receiving module (PRM) 200, according to aspects of the disclosure. FIG. 3 is a schematic perspective view of the back of power receiving module (PRM) 200, according to aspects of the disclosure. The orientation cube provided in the lower corners of FIGS. 2-6 corresponds to faces of PRM 200. The various orientations corresponding to faces of PRM 200 may also be referred to as portions or sides (e.g., a front portion or front side, a left portion or left side, etc.) While not labeled the bottom portion, or bottom side, is opposite the top portion, or top side. The front side may also be referred to as front portion 201, the left side may be referred to as left portion 203, the right side may be referred to as right portion 205, the top side may be referred to as top portion 207, and the back side may be referred to back portion 209.

PRM 200 contains one or more subsystems, as described in greater detail below with respect to FIGS. 2-6. PRM 200 may be configured such that it is geometrically and electrically compatible with a variety of machines types, such as the mining truck exemplified by machine 100. One of ordinary skill in the art will appreciate that machines may be designed in a manner to accept and utilize PRM 200 (e.g., multiple machines 100, including different types of machines, are designed to be compatible with PRM 200). Implementation of air cooling in PRM 200, as compared to liquid cooling reduces the overall volume of PRM 200. This decrease in volume PRM 200 increases the available volume for other systems and components in machine 100 (e.g., battery module 205), further reduces the total weight of machine 100, reduces total plumbing distance, and reduces potential coolant leak points for remote positioning of the PRM 200.

PRM 200 includes a low voltage electrical system 210. Low voltage electrical system 210 is coupled and/or electrically connected to one or more relatively low-voltage components for example, a temperature sensor 231. Low voltage electrical system 210 may have differing physical properties as compared to a high voltage harness. For example, low voltage electrical system 210 has different electromagnetic field interference (EMI), heat tolerance, chemical resistance, insulation, among other characteristics. Low voltage electrical system 210 may also be referred to as electrical circuit 210.

Low voltage electrical system 210 may interface with the high voltage system using an electronic control module (ECM) which may receive outputs from voltage sensors and current sensors. The ECM may interface with the high voltage components using the aforementioned sensors to reduce the voltage such that the ECM can accept the incoming voltage. The ECM may be able to drive or control relays capable of opening and closing contactors (e.g., contactors 214). The voltage sensors may be electrically isolated high voltage sensors that output low voltage signals. The current sensors may be hall effect sensors that output low voltage signals.

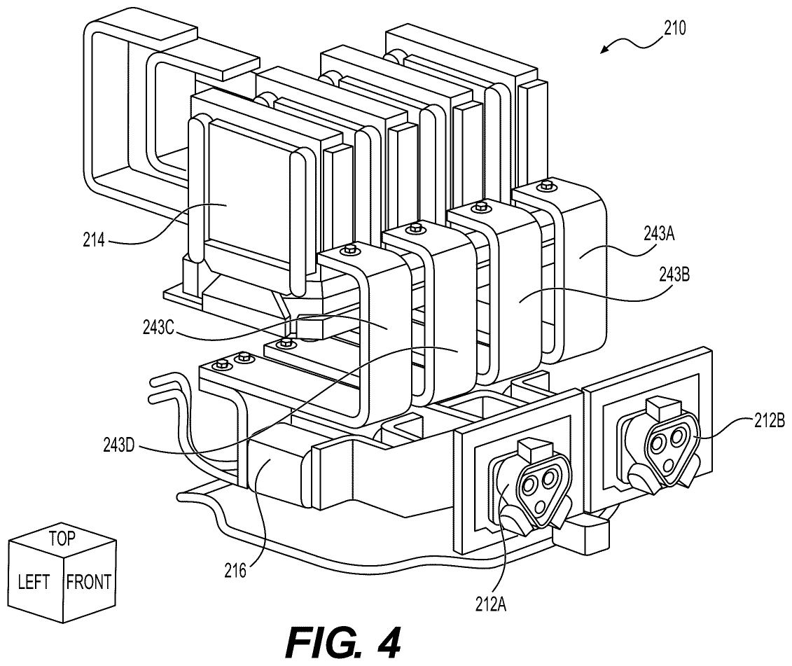

FIG. 4 is a schematic perspective view of low voltage electrical system 210 useful in the power receiving module system of FIG. 2, according to aspects of the disclosure. Low voltage electrical system 210 receives electrical power at a first voltage via one or more receptacles 212A and 212B. Receptacles 212A and 212B are also be referred to as charging inputs 212A and 212B. One or more charging connectors (not shown) electrically connect to low voltage electrical system 210 via receptacles 212A and 212B. Receptacles 212A and 212B may be configured to accept a variety of charging connectors such as J1772, Mennekes, GB/T, CHAdeMO, CCS1, CCS2, and various charging connections standards. It is contemplated that receptacles 212A and 212B may be compatible with charging connection standards not described in the present disclosure, future implementations of charging connection standards, or non-standard (e.g., proprietary) connection devices. Receptacles 212A and 212B may feature different types of connectors (e.g., a first connector being CC2 and a second connector being a proprietary connector). Receptacles 212A and 212B may be configured to accept a relatively high voltage (e.g., 1500 V) as the first voltage. For example, an operator may initiate charging during a period of downtime by inserting a charging connector into receptacles 212A and 212B of machine 100.

Low voltage electrical system 210 includes one or more contactors 214. While four contactors are shown in FIG. 4, other quantities of contactors 214 may be used with the systems, devices, and methods of the disclosure. Contactors 214 are electrically-controlled switches that may receive one or more signals from a controller 220. The signals transmitted by controller 220 may cause contactors 214 to actuate such that power is routed from low voltage electrical system 210 to other subsystems of PRM 200. Contactors 214 may be switched on an individual basis to route power through PRM 200. For example, contactors 214 receive signaling such that three of four contactors route power to a high voltage circuit, while a fourth contactor routes power through low voltage electrical system 210. Controller 220 may be configured to prevent low voltage electrical system 210 from exceeding a predefined voltage via switching of one or more contactors 214.

Low voltage electrical system 210 may include one or more fuses 216. Fuses 216 serve as sacrificial electrical safety devices configured to break the circuit of low voltage electrical system 210 if a predefined current is exceeded. Fuses 216 protect low-voltage systems electrically connected to low voltage electrical system 210 from overcurrent conditions.

Returning to FIG. 2, PRM 200 includes a controller 220. Controller 220 controls various electrical components of PRM 200 such as contactors 214. For example, controller 220 may transmit signals to contactors 214 to connect or break various electrical connections. Controller 220 may include a processor and firmware, network connectivity (for example, a 5G and/or satellite connection, and various contemplated future networking implementations such as 6G), and various components used to identify the type of connector that is connected to machine 100. Controller 220 may communicate with a charger connected to machine 100, with battery modules 205, and with the electrical systems of PRM 200 to coordinate charging output of PRM 200 with charging requirements of machine 100. Controller 220 communicates (via its network connectivity) charge states of machine 100 (e.g., state of charge for one or more of batteries 205), a total cost of electricity used for charging, a total greenhouse gas footprint associated with a current charging operation or a cumulative sum of charging operations, start and stop times of charging, temperature, battery health of machine 100, and a current input power and voltage of a connected charger. For example, an off-site operator may query controller 220 to determine a current charge state of machine 100. Controller 220 may be a single component, or one or more components communicatively and/or operatively linked to one another.

Controller 220 monitors various physical states of PRM 200. For example, controller 220 monitors internal temperatures of PRM 200 via one or more communicatively coupled temperature sensors (e.g., temperature sensor 231). Controller 220 may adjust or modify a speed of an air blower 252 based on the detected thermal conditions (e.g., a sensor reading) to exhaust heat from PRM 200 in accord with a predefined fan curve. The predefined fan curve defines a relationship between detected temperatures and fan speed. Controller 220 monitors various access panel locations (e.g., orientations/configurations) 230A-H of PRM 200 to enhance safety of PRM 200. It will be understood that access panel locations 230A-H are depicted as open holes, but each of access panel locations 230A-H may be configured with a removable/moveable panel or door. For example, access panel 230F may be opened via a hinge 231 and an access panel 233. In another example, access panel location 230H may be configured with an access panel door 235. The panels and doors for access panel locations may vary based on the internal geometry of machine 100. For example, access panel location 230A may include a sliding door and access panel location 230H may include a removable top panel (e.g., access panel door 235). In some aspects, access panels may be fully removable by an operator removing one or more fasteners, locks, latches, and the like. In some aspects, all of access panels associated with access pane locations 230A-H may be of a same type (e.g., sliding) and in other aspects, one or more of access panels associated with access panel locations 230A-H may vary from one another. In some aspects, a first configuration may correspond with an access panel being closed. For example, access panel location 230F is depicted in FIG. 2 is shown with a transparent cover (e.g., access panel 233), corresponding to a first (closed) configuration. Similarly, access panel location 230G is shown in a second (e.g., open) configuration with no transparent cover.

Controller 220 selectively completes circuits, breaks circuits, or powers down or disconnects various electrical connections of PRM 200 when a detected access panel is in an open orientation (e.g., corresponding to an operator servicing PRM 200). Controller 220 monitors access panels 230 with proximity sensors, reed switches, limit switches, pressure mats, RFID (Radio-Frequency Identification), electronic locks, and the like.

For example, an operator is able to remove access panel 230C (shown on left portion 203) to access controller 220 without needing to remove additional components of PRM 200. In another example, an operator may remove access panel 230B (shown on left portion 203) to access and remove receptacle(s) 212A and 212B (e.g., to replace or update a module). It may be beneficial to change the type of receptacle(s) in use based on various operating conditions such as local electrical supply format. In this manner, the modular design of PRM 200 may be adapted to a wide variety of operating conditions with reduced servicing complexity.

In some aspects, certain access panels are designated as-non serviceable (e.g., in a field setting). Such non-serviceable access panels may be designated as such by controller 220. In an example, access panel 235 (corresponding to access panel location 230H and shown on top portion 207) is designated by controller 220 as non-serviceable. Should an operator open access panel 235, controller 220 may be notified by the aforementioned monitoring systems. In response to this notification, controller 220 may sound an alarm, disable charging operations, and/or transmit notification alerts to one or more supervisory systems (e.g., via its cellular connection) when a non-serviceable access door is opened.

FIG. 3 shows one or more voltage transducers 240. Voltage transducers 240 provide measurement and conversion of AC input to a DC output suitable for charging the batteries of machine 100. One of ordinary skill in the art will appreciate that voltage transducers 240 may be configured to output power to the batteries of machine 100 in a suitable format (e.g., correct current, voltage, current type). Voltage transducers 240, grounding busbar 242 and secondary busbars 243A-D may be referred to as high-voltage electrical system 245 or high-voltage circuit 245.

FIG. 2 also shows a grounding busbar 242. Grounding busbar 242 may act as a common connection point between the electrical systems and electrical components of PRM 200 and the ground. Grounding busbar 242 may be composed of a material with a low electrical resistance. Grounding busbar 242 may allow excessive electrical currents to flow into the ground, rather than causing damage to equipment. For example, grounding busbar 242 may prevent excessive current from reaching the batteries of machine 100 (e.g., during a current surge from the electrical charging connection or a lightning strike). Grounding busbar 242 may also act as a heatsink for other components of PRM 200 by acting as a heat reservoir (e.g., grounding busbar 242 may have a large thermal mass).

FIG. 4 further shows secondary busbars 243A-D. Secondary busbars 243 may perform similar functionality as described above with respect to grounding busbar 242. Secondary busbars 243A-D may route excessive electrical charges into grounding busbar 242. While four secondary busbars 243A-D are shown in FIGS. 2 and 4, other quantities of secondary busbars are possible.

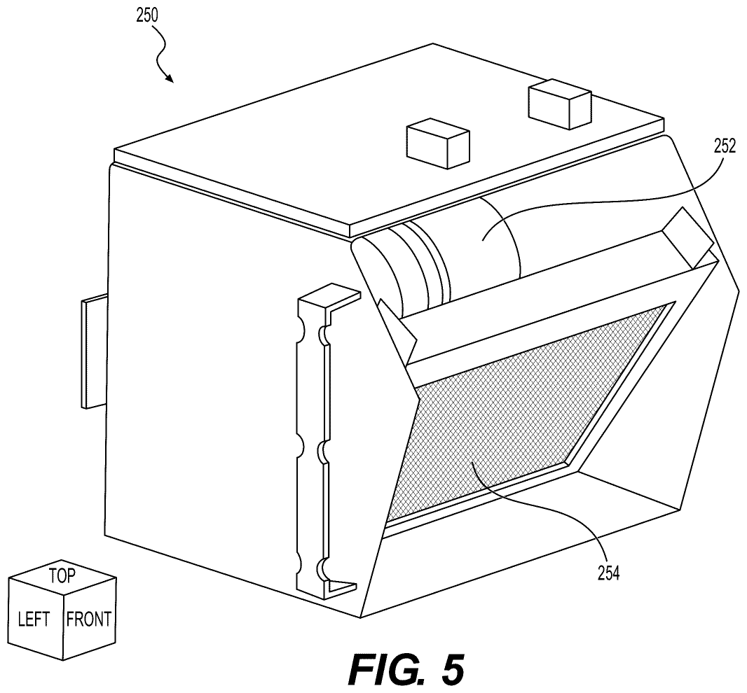

FIG. 5 is a schematic perspective view of an air intake 250 useful in the power receiving module system of FIG. 2, according to aspects of the disclosure. Air intake 250 includes a blower 252, such as a fan or turbine configured to draw in and circulate air through PRM 200. Blower 252 may be positioned approximately perpendicular to the front 202 (e.g., facing to the right side of PRM 200). Air circulation through PRM 200 is used to remove heat from components of PRM 200 that generate heat and conduct heat. Blower 252 pulls cooler outside air to flow into, through, and out of PRM 200.

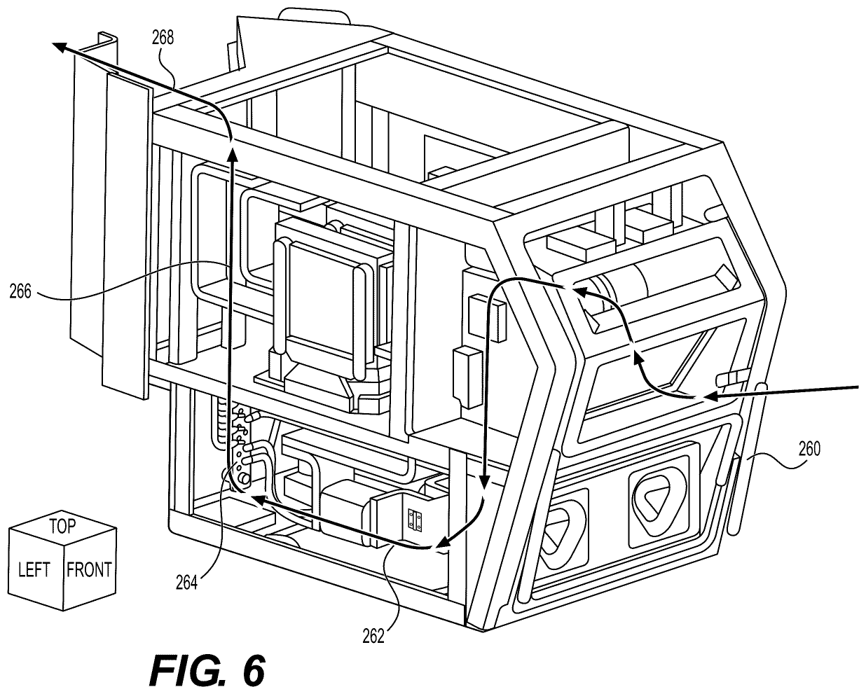

Further description of the air flow path will be provided with respect with FIG. 6. Blower 252 may draw in outside air through a filter 254. Filter 254 may prevent foreign particulate matter such as dust and sand from entering PRM 200 while blower 252 is active. Filter 254 may enhance the cooling properties of air intake 250 by preventing buildup of contaminants on internal surfaces of PRM 200. A diverter plate 272 may be positioned adjacent to the heat exhaust of PRM 200. Diverter plate 272 may be adjustable by an operator to direct hot exhaust air towards a desired location (e.g., out of machine 100). In some aspects, controller 220 may adjust the position of diverter plate 272 via one or more motors (not shown). In some aspects, diverter plate 272 may direct hot exhaust air towards portions of machine 100 that may benefit from heating. For example, diverter plate 272 (via signaling from controller 220) may direct hot exhaust air towards ductwork of machine 100 (not shown) to heat a cabin portion of machine 100 such that the cabin portion is warm for an operator at the beginning of the work day. In this manner, charging waste heat may be repurposed for beneficial uses.

### INDUSTRIAL APPLICABILITY

The PRM 200 of the present disclosure is configured to operate in an industrial environment, and includes features to address the unique hazards and accessibility issues associated with charging a battery-powered vehicle in an industrial environment. For example, industrial vehicles require significant amounts of power to operate, and thus large battery assemblies are used to operate the machine effectively. These large battery assemblies use correspondingly large amounts of power to charge. Unlike vehicles with internal combustion engines that can be quickly refueled, battery-powered electric vehicles experience significantly more downtime while charging. Minimization of charging time increases productivity of machine 100. However, increasing charging speeds to minimize downtime has an associated tradeoff-heat. Increased current corresponds with increased resistive heating of electrical components and subsystems of PRM 200. Machine 100 may also operate in hot environments, which further exacerbates electrical resistance throughout PRM 200, resulting in a positive temperature feedback loop. One of ordinary skill in the art will appreciate that safely evacuating heat from PRM 200 is beneficial.

Air-cooled PRMs offer several advantages over liquid-cooled PRMs. Air cooling may require less complex internal designs than liquid cooled systems. For example, air-cooled PRMs lack coolant pumps, radiators, hoses, and other components associated with liquid cooling. This enhances the durability of PRM 200, for example, by eliminating the risk of coolant leaks within PRM 200. Air-cooled PRMs also have reduced weight compared to liquid cooled PRMs, due to the aforementioned components not being present in an air-cooled PRM. Any potential weight savings in battery-powered electric vehicles may be desirable to partially offset the relatively large weight of electrochemical batteries. The reduced part complexity of an air cooled system reduces the risk that PRM 200 (and machine 100) can be damaged to a cooling system failure. Air-cooled PRMs do not require coolant maintenance (e.g., replacing coolant), which further enhances the uptime of machine 100. The plurality of access panels 230A-H may enhance maintenance procedures for operators by enabling access to the various subsystems of PRM 200. For example, an operator may be able to access or remove a particular subcomponent of PRM 200 via an access panel(s) 230A-H without removing other subcomponents. The components of PRM 200 may be cooled without cooling the batteries 205 of machine 100 (e.g., cooling air is not routed to batteries 205).

FIG. 6 shows an air flow path 260 through PRM 200. Air flow path 260 corresponds with a cooling path through PRM 200. Air flow path 260 is described sequentially, that is, air from blower 252 contacts components in the order that they are described below. Air flow path 260 may begin at air flow position 262. Air flow position 262 may be understood as the initial intake position of outside air (e.g., air from outside of PRM 200). Air located at air flow position 262 may be drawn in to PRM 200 through filter 254 via suction created by blower 252. As described above, air passing through filter 254 may be scrubbed of particulate matter.

Air may flow from air flow position 262 to air flow position 264. Air flow position 264 may be located approximately behind (e.g., towards the back of and/or disposed behind) receptacles 212A and 212B. Receptacles 212A and 212B may generate considerable heat during charging operations. Accordingly, receptacles 212A and 212B may be exposed to the lowest temperature air (corresponding to outside air) relative to the other components along air flow path 260.

Air may flow from air flow position 264 to air flow position 266. Air flow position 266 may correspond to a position approximately nearby fuses 216, contactors 214, transducers 240, and grounding busbar 242. Cooling grounding busbar 242 may increase the conductivity of grounding busbar 242. Increased conductivity of grounding busbar 242 may increase the capability of grounding busbar to dissipate excess charge from PRM 200. Thus cooling grounding busbar 242 may further enhance the safety of PRM 200.

Air may flow from air flow position 266 to air flow position 268. Air flow position 268 may correspond to a position outside of PRM 200. Air may exit PRM 200 (towards air flow position 268) via an air outlet 270. Air outlet 270 may be an outlet, opening, aperture, hole, orifice, and the like. Air outlet 270 may be positioned at the back of PRM 200 (e.g., opposite filter 254). Air passing through outlet 270 may be directed by diverter plate 272. Diverter plate 272 may be configured to direct air in a desired direction. In the exemplary FIG. 6, diverter plate 272 may direct air to the right (this diversion not shown in FIG. 6), though this is only exemplary. One of ordinary skill in the art will appreciate that diverter plate 272 may be positioned in various locations and configurations behind air outlet 270. Diverter plate 272 may be configured to blow exhaust air towards an outlet of machine 100 (not shown). Diverter plate 272 may adjust its orientation based on user (e.g., an operator) input or based on signaling from controller 220.

PRM 200 is used for receiving power at a first voltage via a charging input, transmitting an indication from a controller to an electrical contactor, based on the indication, transitioning the electrical contactor between a first configuration and a second configuration, wherein the second configuration electrically couples a first circuit and a second circuit, converting power from the first voltage to a second voltage via a voltage transducer electrically coupled to the second electrical circuit, supplying power to a battery pack, wherein the battery pack is electrically coupled to the second electrical circuit and configured to accept power at the second voltage and directing air through an air filter disposed on a front portion of the power receiving module via a fan, wherein the air passes over the charging input before passing over at least one of the voltage transducer or the electrical contactor before being discharged from the power receiving module via an air outlet disposed on a rear portion of the power receiving module, wherein the air does not include a battery pack. The method of the disclosure may include determining a temperature via a temperature sensor; and based on the determined temperature, transmitting a second indication from the controller to the fan, wherein the second indication causes the fan to transition from a first fan speed to a second fan speed. It will be understood by one of ordinary skill in the art that an indication may comprise a variety of different forms of electrical communication between the controller, fan, and temperature sensor (e.g., electronic signaling).

PRM 200 provides increased cooling capacity to one or more charging components of machine 100. PRM 200 reduces the weight of machine 100 by removing liquid cooling components. PRM 200 increases operator safety via controller 220 monitoring of access panels 230H, fuses 216, grounding busbar 242 and secondary busbars 243A-D. PRM 200 is modular and enables operators to service one or more components of PRM 200 without unnecessary disassembly of additional components.

It will be apparent to those skilled in the art that various modifications and variations can be made to the disclosed power receiving module without departing from the scope of the disclosure. Other embodiments of the battery system will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

What is claimed is:

1. A power receiving module, comprising:
a front portion;
a back portion;
a charging input disposed on the front portion;
an air intake comprising a blower disposed on the front portion, the blower configured to direct air through the power receiving module along an air flow path, the power receiving module being configured to supply power to a battery pack installed in a machine outside of the power receiving module;
a first electrical circuit, including:
the charging input, the charging input configured to accept power at a first voltage via a charging connector; and
an electrical contactor.

2. The power receiving module of claim 1, further comprising a second electrical circuit, wherein the second electrical circuit is electrically connected to the first electrical circuit via the electrical contactor, the second electrical circuit comprising:
one or more voltage transducers configured to convert the first voltage to a second voltage; and
a grounding portion electrically connected to both the first electrical circuit and the second electrical circuit.

3. The power receiving module of claim 2, further comprising:
a controller configured to transmit signals to the blower and to the electrical contactor, where the signals transmitted to the blower causes the blower to modify a fan speed, wherein signaling transmitted to the electrical contactor causes the electrical contactor to complete or break an electrical connection between the first electrical circuit and the second electrical circuit, and wherein the air flow path is in thermal communication with at least one of the first electrical circuit or the second electrical circuit.

4. The power receiving module of claim 3, wherein the air intake further comprises an air filter disposed on the front portion.

5. The power receiving module of claim 4, wherein the air flow path further comprises:
(1) the air filter, (2) a portion disposed behind the charging input and the grounding portion, (3) a portion disposed behind an electrical fuse and the electrical contactor, and (4) an air outlet.

6. The power receiving module of claim 5, wherein the air outlet further comprises an air diverter plate.

7. The power receiving module of claim 6, wherein an orientation of the air diverter plate is adjustable.

8. The power receiving module of claim 3, further comprising:
a first removable service panel disposed on a left portion of the power receiving module; and
a second removable service panel disposed on a right portion of the power receiving module.

9. The power receiving module of claim 8, wherein the first service panel is configured to transition between a first orientation and a second orientation, wherein the second orientation exposes the controller.

10. The power receiving module of claim 9, wherein the controller is further configured to:
determine a change in orientation of the first service panel; and
based on the determination, transmit a signal to the electrical contactor, wherein the signal causes the electrical contactor to break the first electrical circuit and/or second electrical circuit.

11. The power receiving module of claim 4, wherein the power receiving module further comprises:
a temperature sensor communicatively coupled to the controller.

12. The power receiving module of claim 11, wherein modification of the fan speed is based on a temperature reading generated by the temperature sensor, wherein a first temperature reading at the air filter is less than a second temperature reading at an air outlet.

13. The power receiving module of claim 2, wherein the battery pack comprises a plurality of modules, the plurality of modules comprising a plurality of cells, wherein the battery pack is electrically coupled to the second electrical circuit and configured to accept power at the second voltage.

14. A power receiving module, comprising:
a front portion;
an intake fan disposed on the front portion;
a charging input disposed on the front portion, the charging input configured to accept power at a first voltage via a charging connector;
a voltage transducer configured to convert the first voltage to a second voltage;
a grounding busbar electrically coupled to both a first electrical circuit and a second electrical circuit;
a controller configured to transmit signals for controlling the intake fan and an electrical contactor;
an air flow path in thermal communication with at least the intake fan, the charging input, the voltage transducer and the grounding busbar; and
one or more service panels, wherein at least one of (i) the electrical contactor, (ii) the voltage transducer, the grounding busbar, or (iv) the controller is accessible from the power receiving module via at least one of the one or more service panels.

15. The power receiving module of claim 14, wherein the air flow path further comprises, in sequential order:
(1) an air filter disposed on the front portion (2) a portion disposed behind the charging input and the grounding busbar, (3) a portion disposed behind the electrical contactor, and (4) an air outlet disposed on a back portion.

16. The power receiving module of claim 14, wherein signaling transmitted to the controller causes the controller to modify a fan speed and wherein signaling transmitted to the electrical contactor the electrical contactor to complete or break an electrical connection between the first electrical circuit and the second electrical circuit.

17. The power receiving module of claim 15, wherein the air outlet further comprises an air diverter plate.

18. The power receiving module of claim 17, wherein an orientation of the air diverter plate is adjustable.

19. A method performed by a power receiving module, comprising:
receiving power at a first voltage via a charging input;
transmitting an indication from a controller to an electrical contactor;
based on the indication, transitioning the electrical contactor between a first configuration and a second configuration, wherein the second configuration electrically couples a first circuit and a second circuit;
converting power from the first voltage to a second voltage via a voltage transducer electrically coupled to the second electrical circuit;
supplying power to a battery pack, wherein the battery pack is electrically coupled to the second electrical circuit and configured to accept power at the second voltage; and
directing air through an air filter disposed on a front portion of the power receiving module via a fan, wherein, once inside the power receiving module, the air passes over the charging input before passing over at least one of the voltage transducer or the electrical contactor, the air being discharged from the power receiving module via an air outlet disposed on a rear portion of the power receiving module.

20. The method of claim 19, further comprising:
determining a temperature via a temperature sensor; and
based on the determined temperature, transmitting a second indication from the controller to the fan, wherein the second indication causes the fan to transition from a first fan speed to a second fan speed.
